(19) United States
(12) Patent Application Publication
(10) Pub. No.: US 2002/0038596 A1
(43) Pub. Date: Apr. 4, 2002

(54) Methods and apparatus for stretching strings on a musical instrument

(76) Inventor: Matthew I. Lome, Chicago, IL (US)

Correspondence Address: DONNA E. BECKER, BRINKS HOFER GILSON & LIONE, NBC TOWER - SUITE 3600, 455 N. CITYFRONT PLAZA DRIVE, CHICAGO, IL, 60611, US

(21) Appl. No.: 09/894,407

(22) Filed: Jun. 28, 2001

Related U.S. Application Data
(60) Provisional application No. 60/215,368, filed on Jun. 29, 2000.

(51) Int. Cl. G10G 7/00

(52) U.S. Cl. 84/458

(57) ABSTRACT

Methods and apparatus for stretching the strings on a musical instrument such as the guitar are disclosed. A device for stretching the strings of a musical instrument comprises a handle, the handle having two ends, a base, and a tip; an axle, defining an axis, the axle being connected to the handle; and a wheel, the wheel revolving around the axle, and the wheel including a groove, the groove being adapted to receive a string of a musical instrument.

Pursuant to 35 U.S.C. § 120 and 35 U.S.C. § 119(e), Applicant claims priority to copending U.S. Provisional Application No. 60/215,368, entitled Methods and Apparatus for Stretching Strings on a Musical Instrument, filed Jun. 28, 2001.

### BACKGROUND

Strings on musical instruments have the potential to stretch, especially when they are new. As the strings stretch, the instrument falls out of tune or “goes flat.” By pre-stretching new strings, the likelihood of the instrument staying in tune while it is played is greatly increased.

It is conventional wisdom that new strings should be stretched before playing them. Currently, the popular method of stretching strings is to use one's fingers and tug or pull on the strings. This technique, however, has several disadvantages. It can be painful, and generally the stretching that occurs is not thorough or uniform.

### BRIEF SUMMARY OF THE INVENTION

The present invention relates to methods and apparatus for thoroughly and uniformly stretching the strings of a musical instrument. The string stretching device of the present invention allows the thorough and uniform stretching of each individual string on an instrument, whether the string is made of steel or nylon, as traditionally used, or some other material. The string stretching device is generally used before tuning the instrument, after one or more old strings have been replaced with new ones. The string stretching device comprises a handle with a wheel attached to one end of the handle, the wheel being able to freely rotate and including a groove adapted to receive a string of a stringed instrument.

By using the string stretching device and rolling it along the string while applying an appropriate and steady amount of force, the user successfully stretches the strings on the musical instrument, and does so uniformly. As used herein “appropriate amount of force” is defined as the amount of force needed to stretch the string without damaging it. The amount of force needed varies depending on the type of string, including the type of material used and the thickness of the string. One of ordinary skill in the art can readily determine the amount of force necessary to apply to a string to stretch it without damaging or overstretching the string. The device of the present invention aids in the tuning of stringed musical instruments such as the guitar, and allows the strings to maintain their new-string tone quality as long as they are not over-stretched. It is not desirable to use an excessive amount of force when stretching a string on a musical instrument. Excessive force can result in damaging the string either by breaking it or by destroying the string's elasticity.

### BRIEF DESCRIPTION OF THE DRAWINGS

FIG. 1 illustrates the string stretching device as it is used to stretch a string of an acoustic guitar.

FIG. 2 illustrates three component parts present in a preferred embodiment of the string stretching device: a handle, an axle, and a wheel.

FIG. 3 illustrates a top view of the tip of a beveled handle.

FIG. 4 illustrates a close-up view of the tip of a preferred embodiment of a string stretching device.

FIG. 5 illustrates an alternate embodiment of a string stretching device with a straight handle.

FIG. 6 illustrates an alternate embodiment of a string stretching device.

FIG. 7 illustrates a handle that includes an axle in a single structure or in one solid body.

FIG. 8 illustrates a preferred embodiment of a handle of a string stretching device, showing the angles at which certain bends occur in the handle.

FIG. 9 illustrates a side view of one embodiment of a wheel.

FIG. 10 illustrates a cross-sectional view of one embodiment of a groove of a wheel.

FIG. 11 illustrates a cross-sectional view of a wheel showing the adaptation of the groove to receive strings of various sizes.

FIGS. 12A, 12B, 12C, 12D, and 12E illustrate alternate embodiments of wheels with various grooves.

FIG. 13 illustrates the three component parts of one embodiment of a string stretching device including a handle, an axle, and a wheel.

FIG. 14 illustrates one embodiment of an axle wherein the axle is a screw.

FIG. 15 illustrates a preferred embodiment of the head of an axle with a hexagonal slot adapted to receive a hexagonal Allen wrench.

FIG. 16 illustrates an alternate embodiment of a string stretching device comprising a single body or monolithic structure including a handle that is fashioned with a notch at the tip.

FIG. 17 illustrates an alternate embodiment comprising a thimble-style string stretching device.

FIG. 18 illustrates an alternate embodiment comprising a finger-worn string stretching device in the style of a finger worn guitar-pick.

FIG. 19 illustrates a wheel with a V-shaped groove and the manner in which the strings fit into the groove is illustrated.

FIG. 20A illustrates one embodiment of a wheel designed with a wide U-shaped groove at the top, which then sharpens into a V-shaped groove at the bottom.

FIG. 20B illustrates the manner in which strings can fit into a groove.

FIG. 21 illustrates the manner in which a wheel can fit around an axle.

FIG. 22 illustrates a preferred embodiment of a string stretching device.

FIG. 23 illustrates a ball bearing used for the wheel.

### DETAILED DESCRIPTION OF THE PRESENTLY PREFERRED EMBODIMENTS

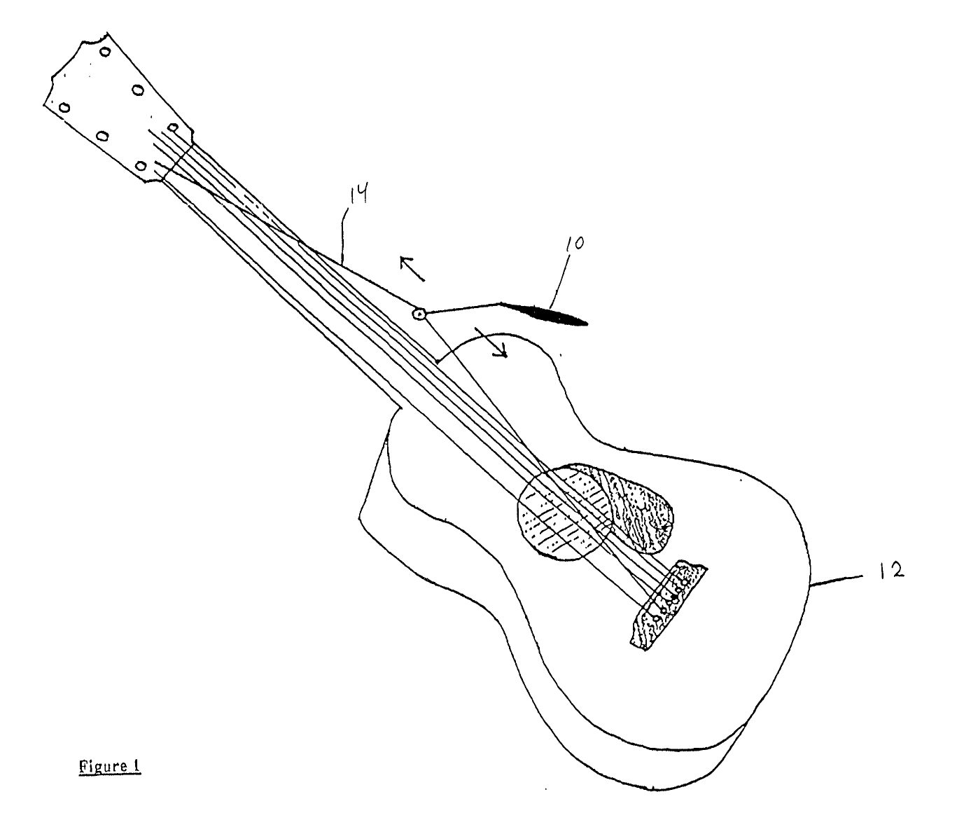

The present invention relates to methods and apparatus for stretching the strings on a musical instrument such as a guitar. (See FIG. 1). The string stretching device (10, FIG. 1, and 220, FIG. 20) of the present invention is a tool which allows thorough and uniform stretching of each individual string (14) on a musical instrument (12), whether the string is made of steel or nylon, or some other material. This invention is preferably used before tuning the instrument, typically after one or more old strings have been replaced with new strings.

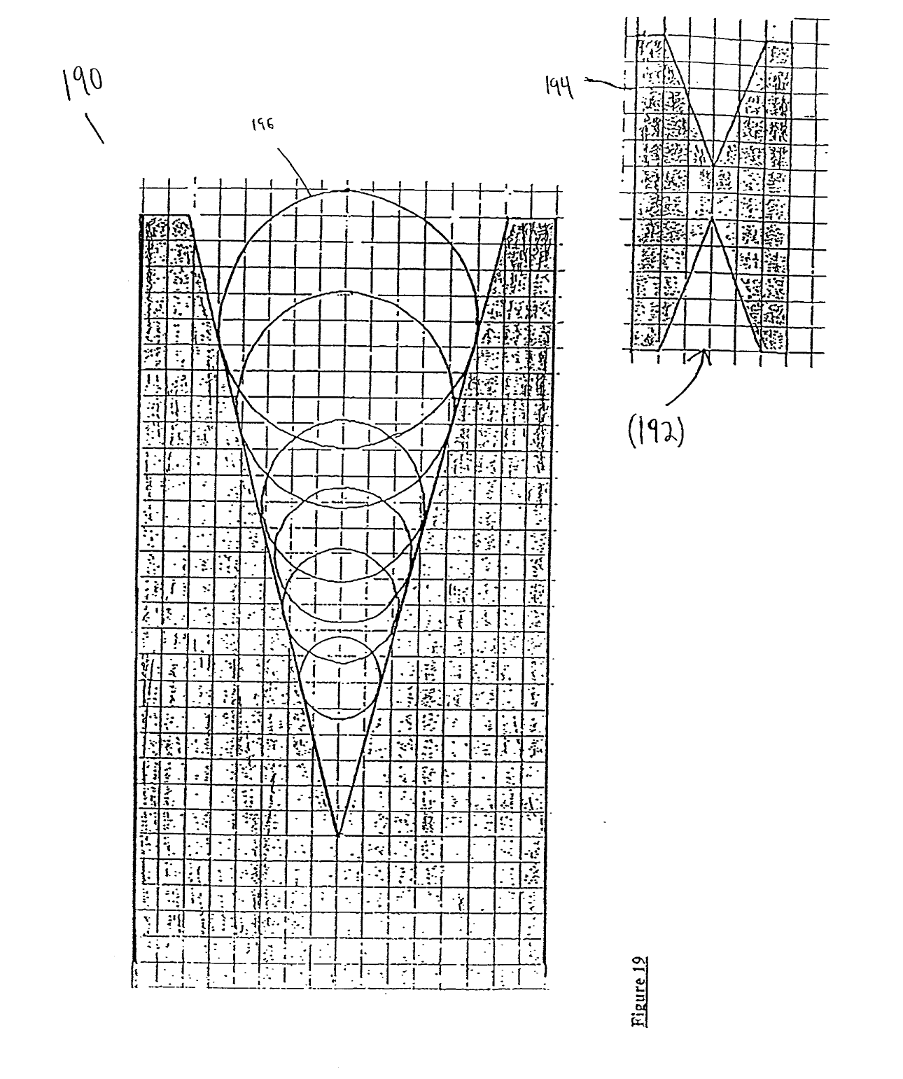

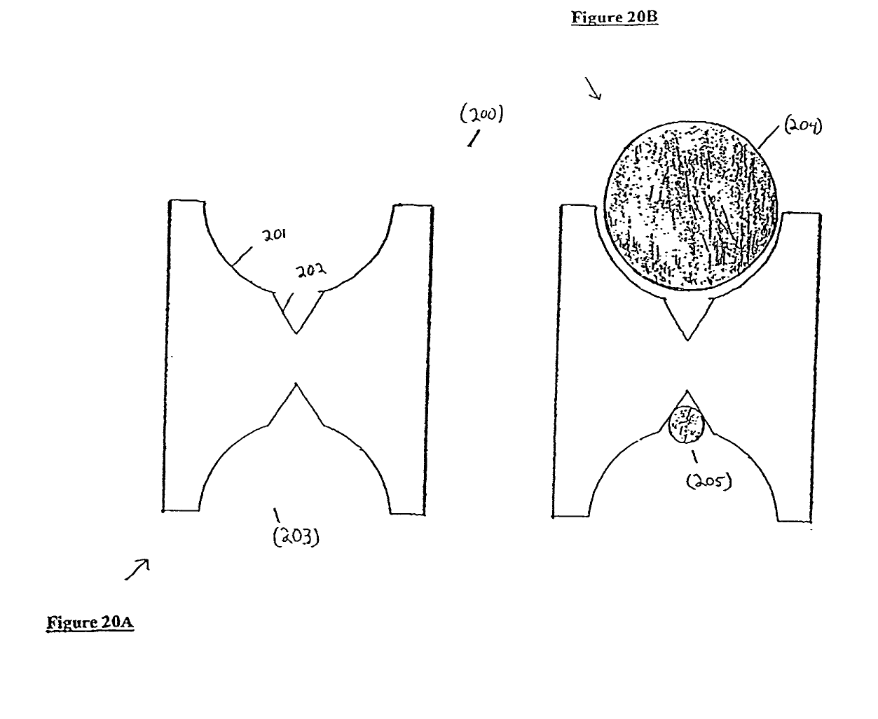

One embodiment of the string stretching device (220) of the present invention comprises a handle (20), the handle (20) having two ends, a base (22) and a tip (26). The base (22) is the end of the handle (20) that is gripped by the user of the device. The tip (26) is the end at which a wheel (28) is attached. (FIG. 2). Preferably, the wheel (28) is able to rotate freely and includes a groove (192) adapted to receive a string of a stringed instrument. (FIG. 19).

During use, the string (196) is cradled inside the groove (192), and then by performing an upward and steady rolling motion, the user is able to roll the wheel (190) along the string (196), thereby stretching it. (FIG. 19).

The purpose of this invention is to thoroughly and uniformly stretch the strings on a musical instrument, such as a guitar, and to aid in the tuning of the instrument. This is accomplished by inserting the string into a groove (224) that runs down the center of the wheel (228). The wheel (228) is attached to a handle (222) by means of an axle (226)—the wheel (228) revolves around the axle (226). By rolling the wheel (228) along the string, while applying a uniform and appropriate amount of upward force, the user successfully stretches a string on a stringed musical instrument. An appropriate amount of force is defined as the amount of force that is needed to stretch the string without damaging it. Pre-stretching the new strings increases the likelihood that an instrument will “hold its tune” as it is played.

### EXAMPLE 1

### Presently Most Preferred Embodiment

The Handle:

For clarity, the handle (20) is described as having three sections: the base (22), the neck (24) and the tip (26). The two ends of the handle (20) are the base (22) and the tip (26). The base (22) is preferably the thicker and wider end of the handle (20), which is gripped by the user. The tip (26) is at the opposite end of the handle (20) from the base (22). The wheel (28) is attached to the handle (20) at the tip (26). (FIG. 2).

An ergonomically shaped handle (20) is designed to be comfortable and practical for use in the human hand. The base (22) of the handle (20) is preferably heavier and thicker than the neck (24) and the tip (26) with additional weight and material at the base (22) for gripping purposes. (FIG. 2).

The width of the handle (20) preferably narrows at the neck (24) of the tool. The neck (24) is characterized by a subtle curve downward, or by a gentle bend in the angle of the handle (20). (FIG. 2). The approximate measurement of this downward angle is preferably about 15 degrees.

There is a small, threaded hole (27) at the tip (26) of the handle (20) which allows attachment of the axle (30), which defines the axis about which the wheel (28) rotates, to the handle (20). In this specific preferred embodiment, the axle (30) is a screw.

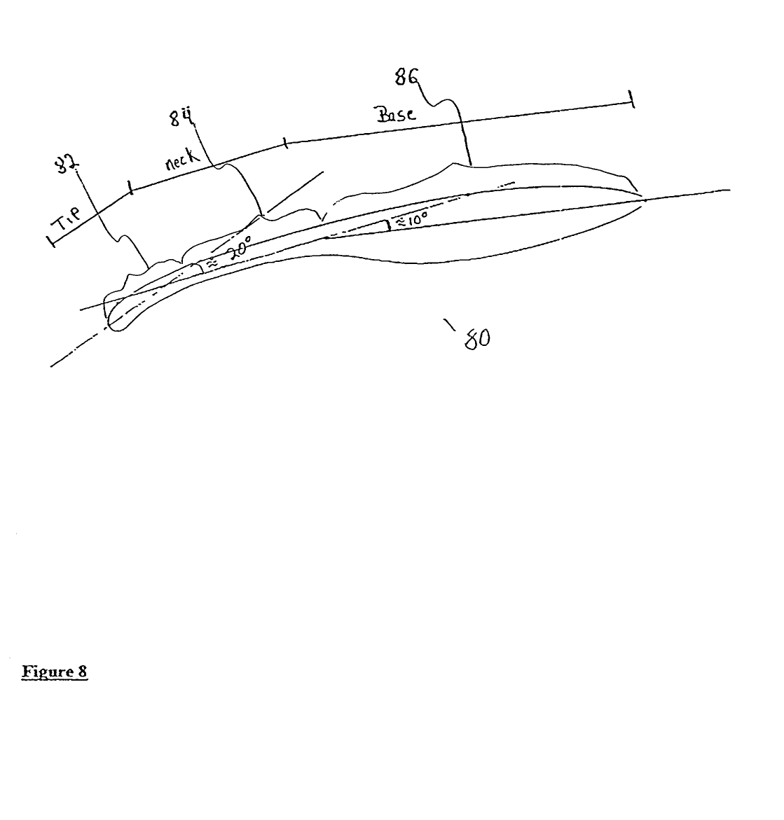

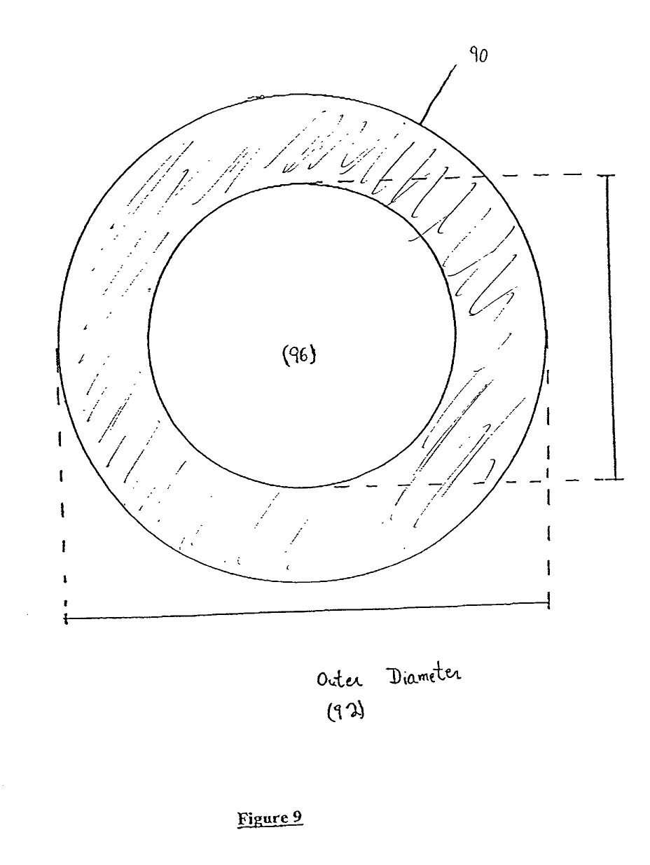

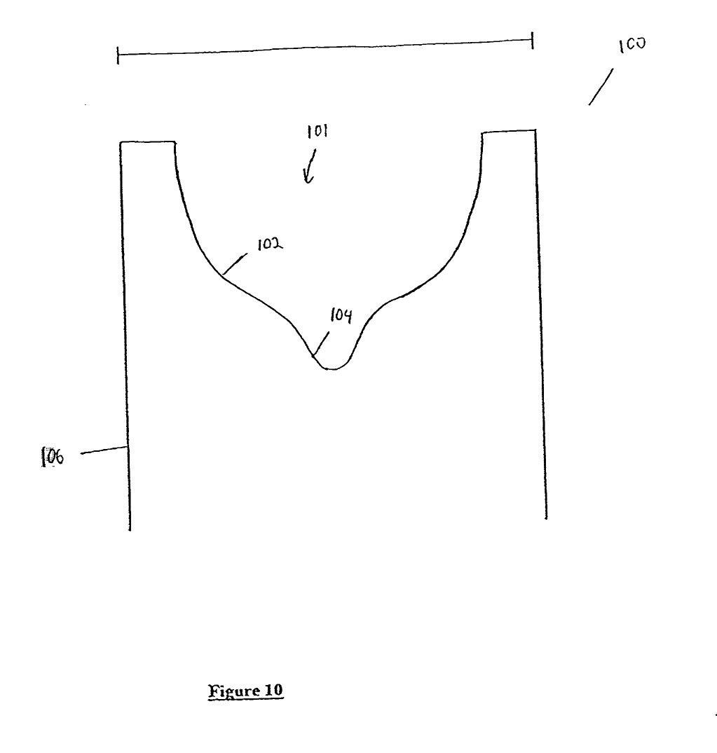

The tip (82) of the tool angles downward from the neck (84), at an angle of preferably about 20 degrees. The angle from the neck (84) to the base (86) is preferably about 10 degrees. Adding these two angles together gives the total angle of the tool which is preferably about 30 degrees. (FIG. 8).

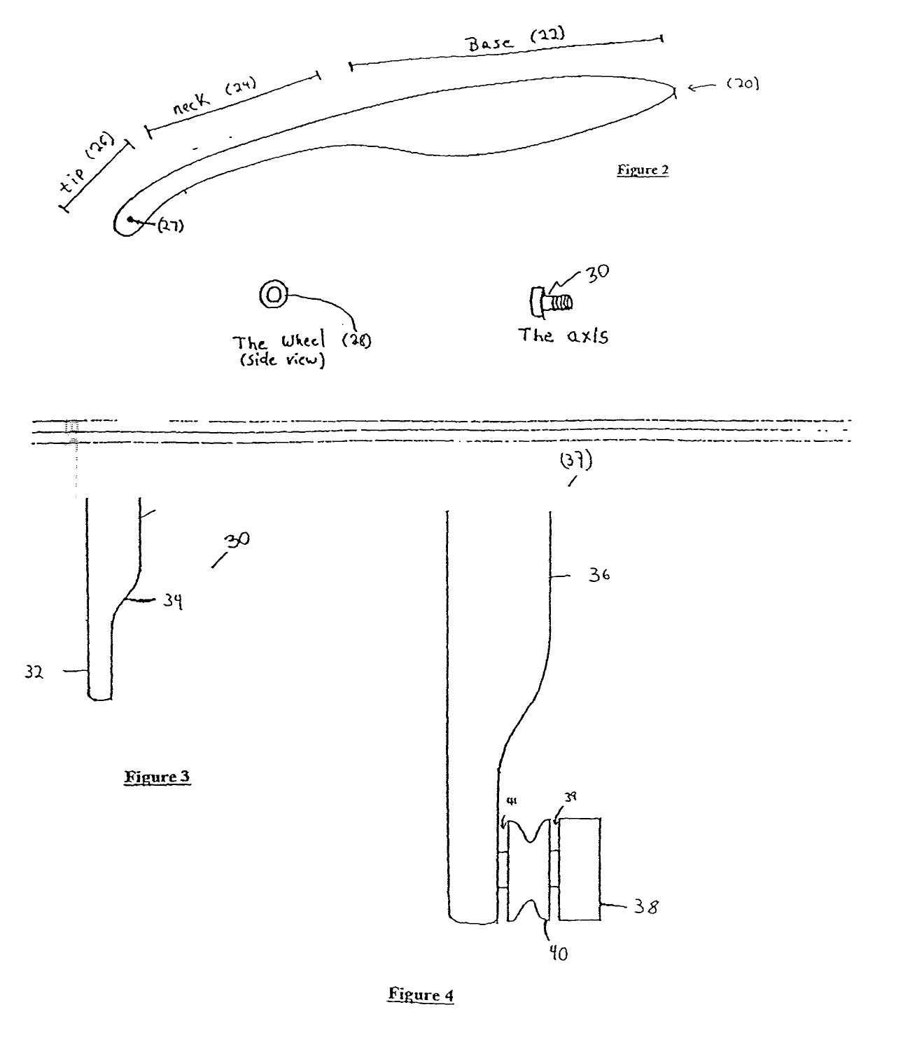

The tip is of the tool is preferably beveled (34) on one side. A top view of the tip (30) as shown in FIG. 3 illustrates the beveling (34). The beveling (34) is advantageous because it makes it easier to grab or engage a string with the device. Also, the beveling (34) helps to retain the proper positioning of the device as it is rolled across the string. Without the beveling, the tool tends to “twist” in the user's hand.

Most preferably, the handle is made of steel, is a smooth texture, and weighs about two ounces Preferably, the handle is fashioned of flat-stock material such as a flat sheet of steel. Preferably, the thickness of the handle is approximately ¼ inch, and at the tip (32), the thickness of the handle is beveled down to approximately ⅛ inch.

The Wheel:

In the present preferred embodiment, the wheel (90) is small and substantially disc-shaped. The outer diameter (92) of the wheel (90) is approximately ¼ inch. The inner diameter (94) or the hole (96) of the wheel (90), into which the axle is inserted, is approximately ⅛ inch. The width of the wheel (90) is approximately ⅛ inch. (FIG. 8). The wheel (90) is preferably of a size that is small enough to ensure that the wheel (90) does not damage the fretboard of the instrument as it rolls along the string.

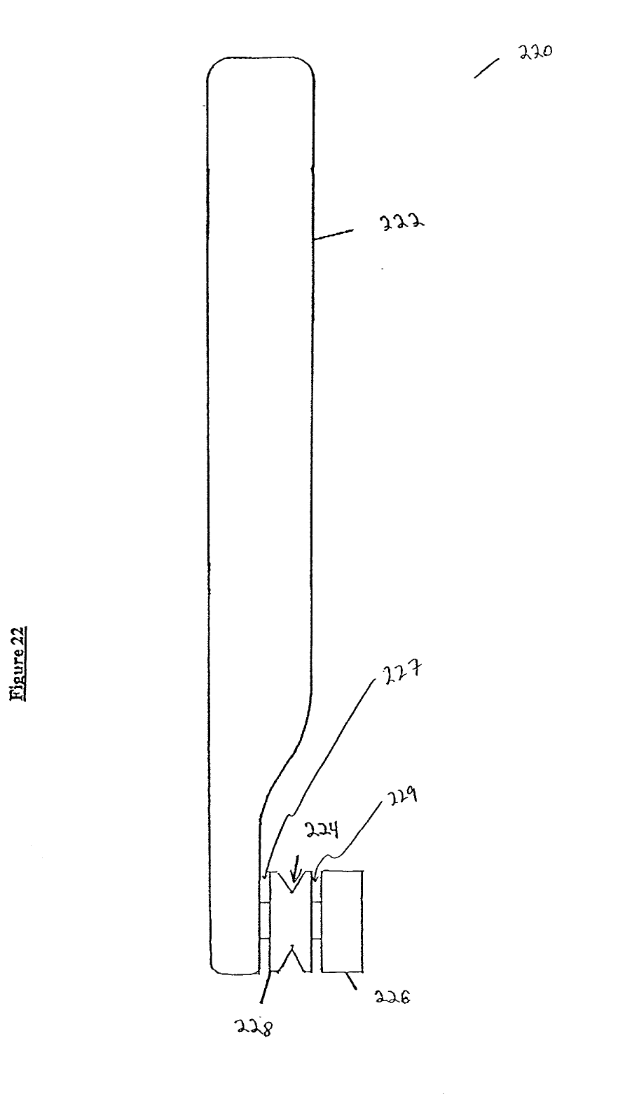

There is a groove (101) that runs along the center of the wheel (106). The groove (101) is adapted to receive a string (114, 116) of a musical instrument, for the purpose of stretching the string. In the present embodiment, the groove (224) is in the shape of a V-shaped wedge. (FIG. 22). Preferably, the wheel is made of stainless steel, is smooth in texture. The wheel most preferably weighs less than about one (1) ounce.

The Axle:

The wheel (134) is attached to the tip of the handle (136) by means of an axle (132). (See FIG. 13). In this preferred embodiment, the axle (132) is a screw. The axle (132) allows for free rotation of the wheel (134)—that is, wheel (134) revolves around the axle (132).

In the assembled device (220), the wheel (228) is attached to the handle (222) by means of an axle (132, 226) preferably, a screw (140). The axle (132) is inserted through the interior hole (96) of the wheel (134), and then is screwed into the small threaded hole (27) at the tip (26) of the handle (20).

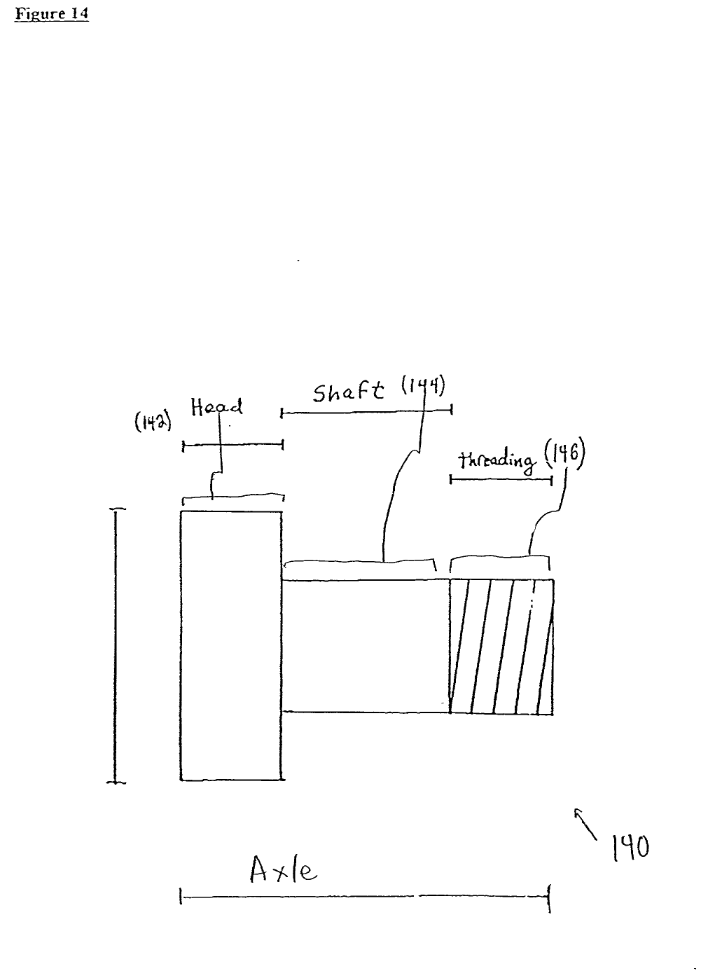

The screw (140), for sake of clarity, is described as having three sections: the head (142), the shaft (144), and the threading (146). (FIG. 14).

The head (142) of the screw (140), is preferably about ⅛ inch in length and about ¼ inch in diameter. The head (142) assures that the wheel (134) remains in position and does will not fall off of the axle (132).

The shaft (144) of the screw is preferably about ⅛ inch in length, and about ⅛ inch in diameter. The shaft (144) is the smooth section of the axle (132) about which the wheel (134) revolves.

The threading (146) is the threaded section of the axle (132). The threading (146) is screwed into a small hole (27) at the tip (26) of the handle (20) in order to attach the axle (132), as well as the wheel (134), to the handle (136).

In the present embodiment, the axle (132) is a screw (140) and is made of stainless steel and most preferably weighs less than about one (1) ounce.

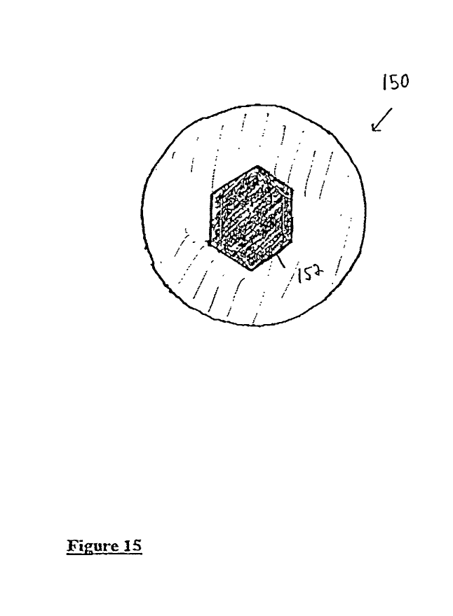

The head (150) of the screw is preferably fashioned with a hexagonal slot (152) that is adapted to receive a hexagonal Allen wrench. (FIG. 15). This allows easy attachment of the axle and the wheel to the handle and adjustment of how tightly the axle and wheel are attached to the handle.

The overall length of the axle (132), including the head (142), the shaft (144) and the threading (146), is preferably about ⅜ inch. (FIG. 14). Preferably, the length of the axle (132) is short enough to ensure that the tool will easily fit between the strings on an instrument.

### Alternate Embodiments

Alternate Sizes:

The string stretching device can be made in different sizes depending on the musical instrument with which it is intended to be used. The string stretching device is preferably sized appropriately for different sizes of musical instruments, and the handle, the wheel, and the axle can vary in size depending on the instrument. For example, if the string stretching device is specifically designed for stretching the strings on a larger instrument with larger and heavier strings, such as a bass or a cello, the device is preferably larger and heavier than a stretching device intended for smaller instruments such as violins and mandolins.

Alternate Embodiments of the Handle;

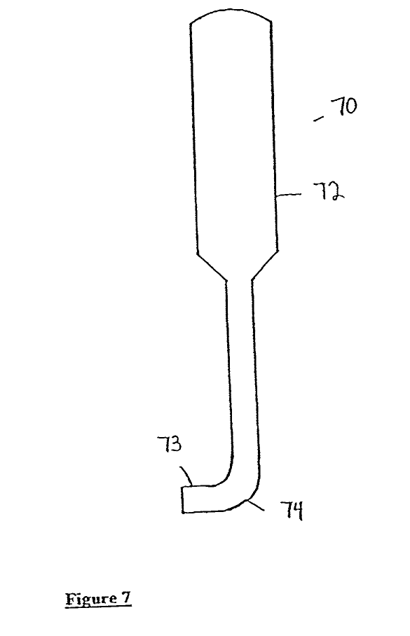

One alternate embodiment of the string stretching device comprises a handle (72) which includes the shaft portion of the axle (73). Rather than two pieces that are mechanically attached or structurally fused together, this handle and axle are part of a solid body or monolithic structure. (FIG. 7).

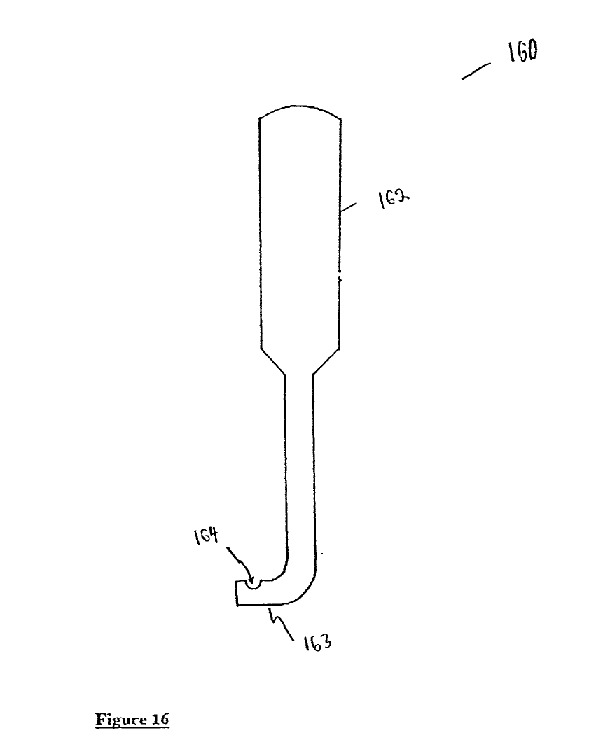

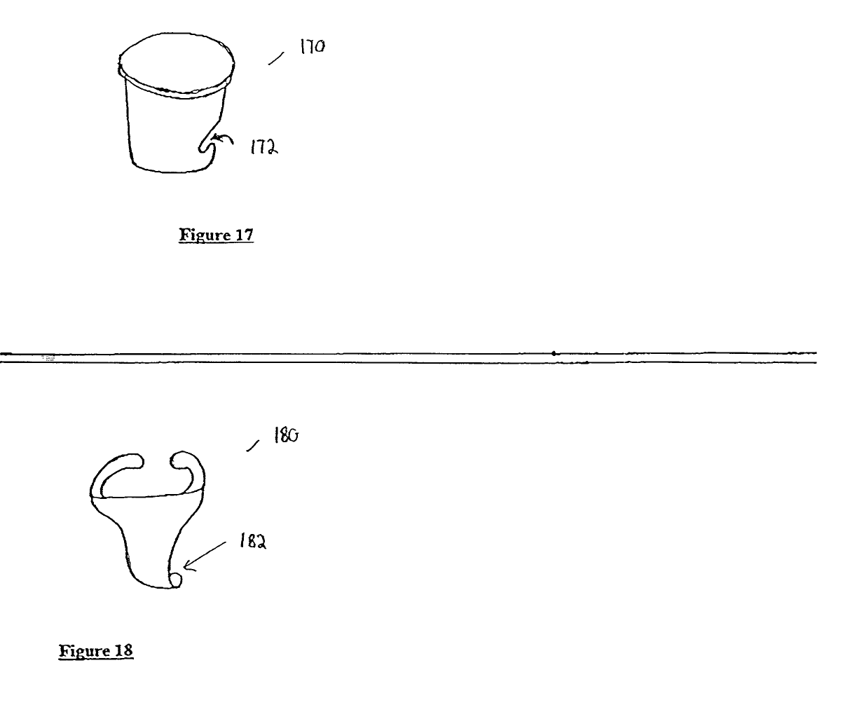

In another alternate embodiment, as shown in FIG. 16, the handle (162), the shaft (163) and a notch (164) are all part of a solid body or monolithic structure, as opposed to the three separate component parts.

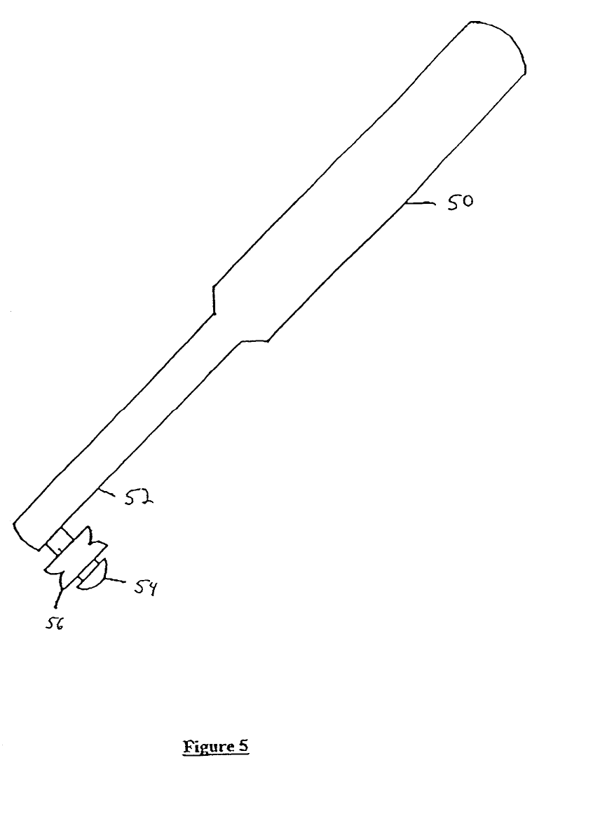

In yet another embodiment, the handle (50) can be made with a tip (52) that is straight and not beveled. (FIG. 5).

The handle can be made of metal alloys such as aluminum or graphite, or the handle can be made of hard nylon, plastic or wood. The handle can be made of any material that can be carved or molded, and is preferably of a weight that is convenient for handling. The handle can vary in texture and in weight; the weight of the handle is preferably under about one (1) pound for the sake of comfort and practicality.

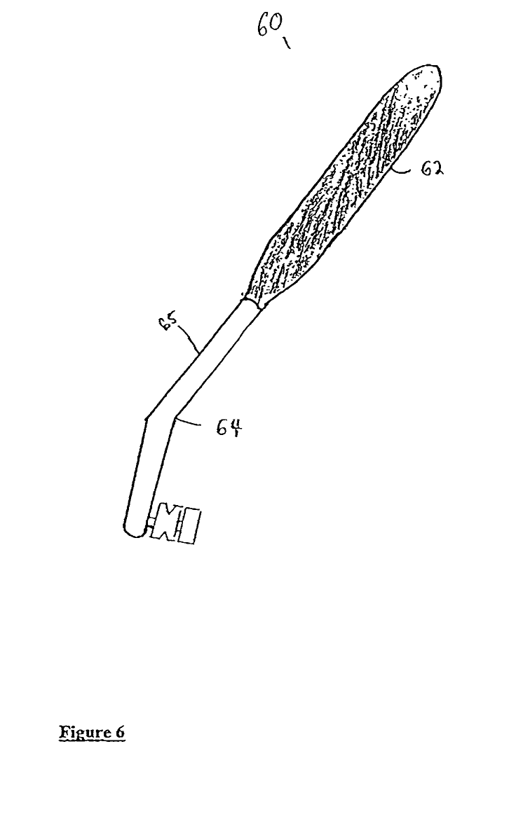

The handle (60) can also be coated. The coating (62) can be added for esthetic reasons and for better gripping. The coating (62) can be rubber, plastic, paint, enamel, or any such material. The coating serves various functions, such as rust protection or to increase longevity. (FIG. 6).

The handle (60) used in alternate embodiments of the string stretching devise can vary in style, shape, and appearance. Preferably, the handle (60) is of a size, shape, and weight that are comfortable and practical for use in the human hand.

Alternate embodiments of the handle (60) can have a bend (64) in the neck of any angle less than 180 degrees. (FIG. 6). Alternatively, the handle (50) can have no bend in it at all. (FIG. 5).

Alternate Embodiments of the Wheel:

While the measurements of the wheel (90) can vary, the outer diameter (92) is preferably about ¼ inch. The diameter of the wheel should be small enough to ensure that the fret board of the instrument is not be damaged by the wheel as it rolls along the string. The interior diameter (94) of the wheel (90) can also vary in measurement, preferably ranging between about 1/16 inch and about ¼ inch, and most preferably, about ⅛ inch.

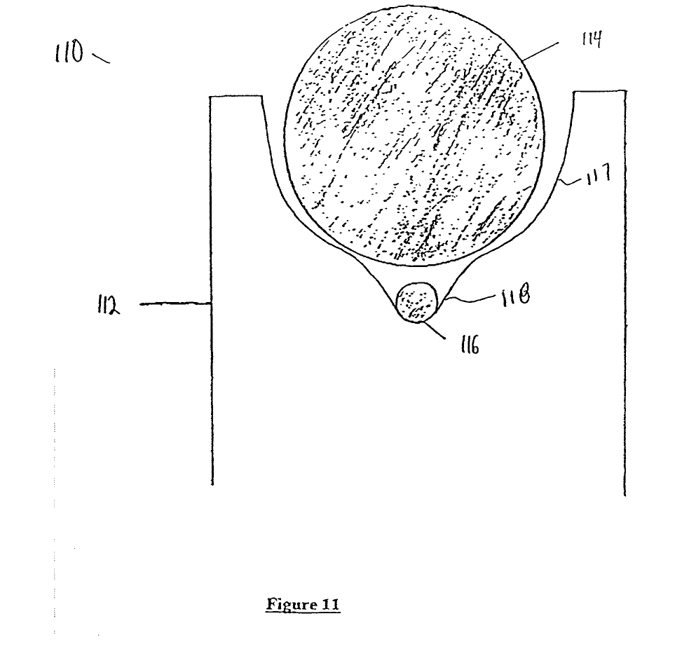

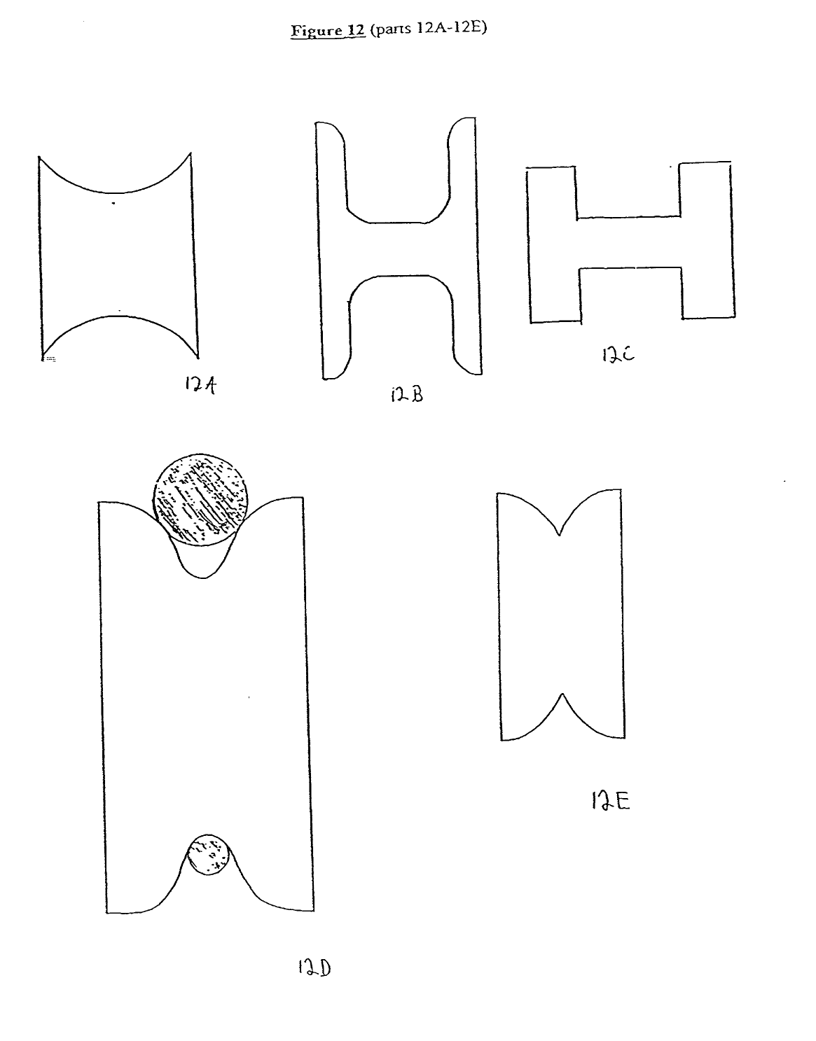

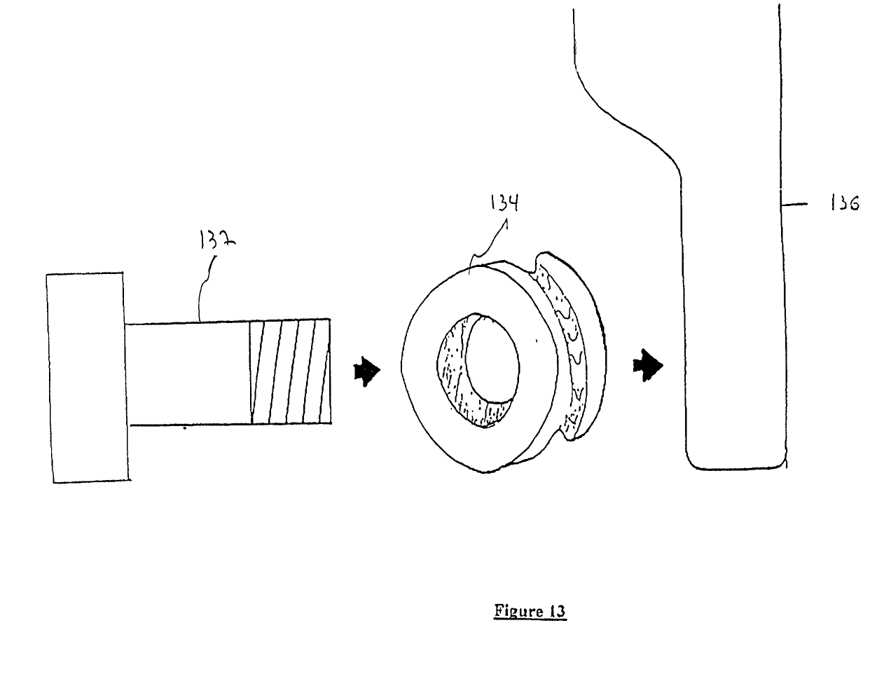

While it is preferred for the wheel (90) to be substantially circular in shape, wheels can differ in style and appearance, as shown in FIGS. 12A, 12B, 12C, 12D, and 12E. If the exterior portion of the wheel is less symmetric than a circle, the wheel may still roll successfully along the strings, if the groove itself is substantially circular.

Alternate embodiments of the wheel can have grooves that vary in shape and measurement. (FIGS. 12A, 12B, 12C, 12D, and 12E). The angle of the groove (192) can be any angle less than 180 degrees as long as there is an angle present with a point or position at which the string rests. Preferably, the groove has an angle of about ninety degrees or less. The groove (192) can “cut” into the wheel at varying depths, as long as it does not cut through to the inner diameter of the wheel, in which case it would cut the wheel in half. Most preferably, the groove is cut to a depth of less than about ⅛ inch. An alternate embodiment of the wheel, shown in FIG. 20A, includes a groove (203) with a U-shaped section (201) and a V-shaped section (202). The upper portion of the groove (203) is the U-shaped section (201), which is the wider section, and accommodates thicker strings (204) on the instrument. The groove (203) then sharpens at the bottom into the V-shaped section (202). This portion of the groove (203) is thinner, and accommodates thinner strings (205).

Another embodiment of the groove (101) has a “double-U-shape” design (102, 104) which serves to accommodate the thickest string (114) on the instrument as well as the thinnest (116). FIG. 11 illustrates the nature of how the various strings fit inside the groove (101). In this “double-U-shape” design, the wider portion of the groove (117) cradles the thicker strings of the instrument, while the deeper and thinner portion of the groove (118) serves to cradle the thinner strings. At its deepest point, the groove (101) cuts to a depth of preferably about 1/16 inch from the outer diameter. (FIG. 8).

The wheel (106) can be made of cast iron, hard nylon, plastic, metal alloys, wood, or any such material that can be molded or carved. Alternate embodiments of the wheel can vary in texture and weight. Preferably, the weight of the wheel is less than about one ounce for the sake of practicality and ease of function.

Alternate Embodiments of the Axle:

Alternate embodiments of the string stretching device can employ an axle (54) such as a pin, a rod, or any such axle that adequately allows the wheel (56) to rotate around it freely. The axle (54) can be attached to the handle mechanically, such as in the case of a screw (140), or structurally by welding or by soldering.

The axle can be made of metal alloy, nylon, plastic, or any building material that can be molded or carved. The axle is preferably smooth in texture to promote uniform and smooth rolling of the wheel. The axle can vary in weight. However, the weight is preferably under approximately one (1) ounce for the sake of comfort and practicality.

The axle (73) can also be incorporated into part of the same solid body as the structure of the handle (72). In this case, the handle (72) and the axle (73) are one solid body or monolithic structure. (FIG. 7).

Wheel Position in Relation to the Axle and to the Handle:

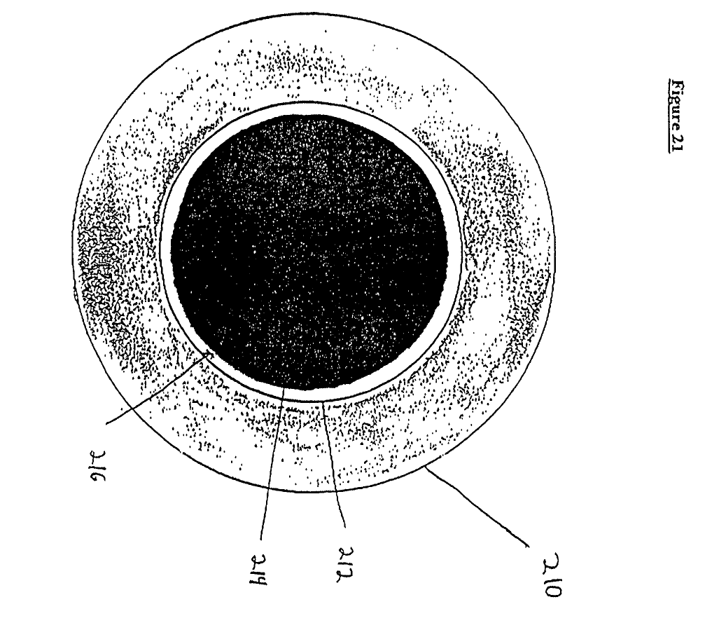

In a preferred embodiment of the string stretching device (220), there is a slight space or gap (216) between the inner diameter of the wheel (212) and the axle (214). That is to say, the hole in the wheel (96) is just slightly larger than the diameter of the axle (214). (FIG. 21). The purpose of this space or gap (216), which measures preferably about a few one-hundredths of an inch, is to promote smooth and easy rolling of the wheel along the string. It is found that a small gap (216) is advantageous because it decreases friction between the axle (214) and the wheel (210).

In a preferred embodiment, as shown in FIG. 4 and FIG. 22, there is a small space (39), or gap, between the wheel (40, 228) and the fastening mechanism (38, 226); and a small space (41, 227) between the wheel (40, 228) and tip of the handle (36. 222). This small space (39,41 and 227,229) on either side of the wheel (40, 228) is desirable, as opposed to a perfectly flush fit, because it lessens the friction and aids in the smooth rolling of the wheel (40. 228). (FIG. 4 and FIG. 22).

Interchanging Wheels:

In one preferred embodiment of the string stretching device, the axle is a screw (140). The axle, in this case, the screw (140), can be removed and replaced with a second screw of different measurements. When the first axle is replaced, the first wheel can also be removed and replaced with a second wheel, one of differing measurements than the first wheel. The first wheel is designed to fit with the first screw, and the second wheel is designed to fit the second screw, etc.

The purpose of an interchangeable axle (132) and wheel (134) is to accommodate different musical instruments, which have strings of varying thickness. For example, the bass guitar traditionally uses much thicker strings than does a standard guitar. Therefore, it is advantageous to have a larger wheel with a wider and deeper groove in order to stretch the strings on a bass guitar. This advantage holds true whether the strings are thicker than those of a standard guitar, such as on a bass guitar, or thinner, such as on a mandolin or a violin.

Employing the use of Ball-Bearing (or other rotational mechanism):

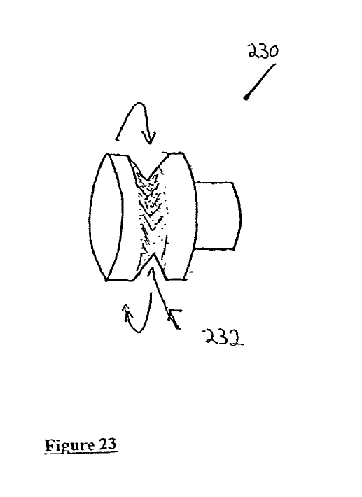

An alternate embodiment of the string stretching device uses a ball bearing (230), or any such similar rotational mechanism, to serve as both the axle and the wheel. (FIG. 23). In this embodiment, the axle and the wheel can be incorporated into the same structure. The wheel spins in a fashion similar to a ball bearing (230). In this embodiment, the ball bearing (230) is fashioned with an appropriate groove (232). Although the use of a ball bearing may enhance the precision and handling of the device, the use of a ball-baring (or other such rotational mechanism) may be cost prohibitive.

Excluding a Revolving Wheel:

An alternate embodiment of the string stretching device (160), as shown in FIG. 16, is fashioned as a solid body or monolithic structure, without the composite structure of a separate handle, a separate axle, and separate wheel. FIG. 16 illustrates one such embodiment, wherein one solid body includes the handle (162), which is curved at the tip and fashioned with a notch (164). The notch (164) is designed to hook a string on a musical instrument for the purpose of stretching the string by pulling. Mechanically, this constitutes a solid body or single unit.

Other embodiments of the string stretching device are fashioned into a thimble design (170) or a finger-warn guitar pick (180). The thimble-style embodiment (170) contains a groove or a notch (172) which is adapted to receive a string on a musical instrument, for the purposes of stretching the string. (FIG. 17). Another embodiment of the device is fashioned in the style of a finger-worn guitar pick (180) in which a groove or hook (182) is included to of receiving a string on a musical instrument, for the purpose of stretching the string by pulling.

Multiple Use Device:

The string stretching device can also be incorporated into a multiple use device. In the spirit of a pocketknife, the string stretching device can be incorporated into a multiple use musicians' tool or into a more general multiple use tool such as a pocket knife.

There has been disclosed, in accordance with the present invention, methods and apparatus for stretching the strings of a stringed musical instrument. Although the invention has been described and illustrated with reference to specific illustrative embodiments thereof, it is not intended that the invention be limited to those illustrative embodiments. Those skilled in the art will recognize that variations and modifications can be made without departing from the spirit of the invention. It is therefore intended to include within the invention all such variations and modifications that fall within the scope of the appended claims and equivalents thereof.

1. A device for stretching the strings of a musical instrument comprising:
a handle, the handle having two ends, a base, and a tip, the base being adapted for gripping;
an axle, defining an axis, the axle being connected to the handle; and
a wheel, the wheel revolving around the axle, and the wheel including a groove, the groove being adapted to receive a string of a musical instrument.

2. A device for stretching the strings of a musical instrument comprising:
a handle, the handle having two ends, a base, and a tip,
the tip including a notch adapted to receive a string of a musical instrument.

3. A method of stretching a string of a musical instrument comprising:
providing a string stretching device comprising a handle, the handle having two ends, a base, and a tip, the base being adapted for gripping, and the tip including a notch adapted to receive a string of a musical instrument;
engaging a string of a musical instrument in the notch;
applying an upward force on the string stretching device while moving the string stretching device across at least part of the length of the string.
